(19) United States
(12) Patent Application Publication
(10) Pub. No.: US 2024/0045070 A1
(43) Pub. Date: Feb. 8, 2024

(54) DENSE SENSOR POD ASSEMBLY

(71) Applicant: Kodiak Robotics, Inc., Mountain View, CA (US)

(72) Inventors: Laura Weeks Shane, Park City, UT (US); Jay Kuvelker, San Francisco, CA (US)

(21) Appl. No.: 17/881,366

(22) Filed: Aug. 4, 2022

(51) Int. Cl. G01S 17/931; G01S 7/481

(52) U.S. Cl. CPC G01S 17/931; G01S 7/4813

(57) ABSTRACT

A dense sensor pod assembly for a vehicle. The dense sensor pod assembly includes a sensor pod housing, a connecting assembly, and a scanning lidar. The sensor pod housing includes one or more sensors located within the sensor pod housing. The connecting assembly couples the sensor pod housing to the vehicle. The scanning lidar is located within the connecting assembly. The scanning lidar, the connecting assembly, and the sensor pod housing form a dense sensor pod configuration.

### CROSS REFERENCE TO RELATED APPLICATIONS

The present application is related to co-pending U.S. Application Attorney Docket No. 143805.565477, filed Aug. 4, 2022, the entire contents of which are hereby incorporated by reference in its entirety.

### TECHNICAL FIELD

The present disclosure relates to a dense sensor pod assembly, and, more particularly, a dense sensor configuration for a sensor pod.

### BACKGROUND

Vehicles include side mirrors connected to the vehicle. Some side mirrors may be equipped to gather data and information, communicate with the vehicle, and may assist in navigating the vehicle.

### BRIEF SUMMARY

According to an embodiment, a dense sensor pod assembly for a vehicle includes a sensor pod housing having one or more sensors located within the sensor pod housing, a connecting assembly for coupling the sensor pod housing to the vehicle, and a scanning lidar located within the connecting assembly, wherein the scanning lidar, the connecting assembly, and the sensor pod housing form a dense sensor pod configuration.

According to an embodiment, a dense sensor pod assembly for a vehicle includes a sensor pod housing, a connecting assembly for coupling the sensor pod housing to the vehicle, and one or more sensors located within the connecting assembly, wherein the one or more sensors, the connecting assembly, and the sensor pod housing form a dense sensor pod configuration.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates a perspective view of a vehicle, according to an embodiment of the present disclosure.

FIG. 2 illustrates a perspective view of a vehicle, according to an embodiment of the present disclosure.

FIG. 3 illustrates a perspective view of a sensor pod with a connecting assembly, according to an embodiment of the present disclosure.

FIG. 4 illustrates another perspective view of the sensor pod of FIG. 3, according to an embodiment of the present disclosure.

FIG. 5 illustrates a side elevation view of the sensor pod of FIG. 4 with a cut away view illustrating internal components of the sensor pod and connecting assembly, according to an embodiment of the present disclosure.

FIG. 6 illustrates a side elevation view of the sensor pod of FIG. 4 with a cut away view illustrating an alternative arrangement of internal components of the sensor pod and connecting assembly, according to an embodiment of the present disclosure.

FIG. 7 illustrates a perspective view of a sensor pod with a connecting assembly, according to an embodiment of the present disclosure.

FIG. 8 illustrates a side elevation view of the sensor pod of FIG. 7 with a cut away view illustrating internal components of the sensor pod and connecting assembly, according to an embodiment of the present disclosure.

FIG. 9 illustrates a side elevation view of the sensor pod of FIG. 7 with a cut away view illustrating an alternative arrangement of internal components of the sensor pod and connecting assembly, according to an embodiment of the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location or importance of the individual components.

The terms “forward” and “rearward” refer to relative positions of a vehicle. For example, forward refers to a position closer to front hood, front bumper, or front fender of the vehicle and rearward refers to a position closer to a rear bumper, rear trunk, or trailer of the vehicle.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values and/or endpoints defining range(s) of values.

Vehicles include sensor pods connected to the vehicle. The sensor pods gather data and information, communicate with the vehicle, and may assist in navigating the vehicle. The sensor pods include a variety of sensors, cameras, and mirrors to gather the data and information, communicate with the vehicle, and where applicable, assist in navigating the vehicle. Additional components are included to complement the sensors, cameras, and mirrors, such as, for example, heat sinks for removal of heat generated by the sensors and/or cameras, one or more conduits for providing air and/or water to the sensors and/or cameras to assist in operation and/or cleaning of the sensors and/or cameras, conduits for providing power and for allowing two-way communication with the sensors, cameras, and mirrors. The sensors, cameras, mirrors, and the additional components contribute to a weight and size (e.g., length, height, width) of the sensor pod. The weight and size of the sensor pod generates a moment on the connecting assembly.

There remains a need for improved assemblies, systems, and methods for connecting, arranging, and assembling the sensors, cameras, mirrors, and additional components of the sensor pods to minimize a weight and a size of the sensor pod, thus, minimizing or reducing the moment generated on the connecting assembly by the sensor pod, while maintaining operability and functionality of the sensor pod. As described and shown herein, the improved assemblies, systems, and methods may include, for example, but not limited to, locating one or more sensors and/or cameras within at least a portion of a connecting assembly of the sensor pod, locating one or more sensors and/or cameras conventionally located outside of the sensor pod housing, within at least a portion of a housing of the sensor pod, locating one or more related components, such as, for example, a heat sink and/or one or more conduits, within at least a portion of a connecting assembly of the sensor pod.

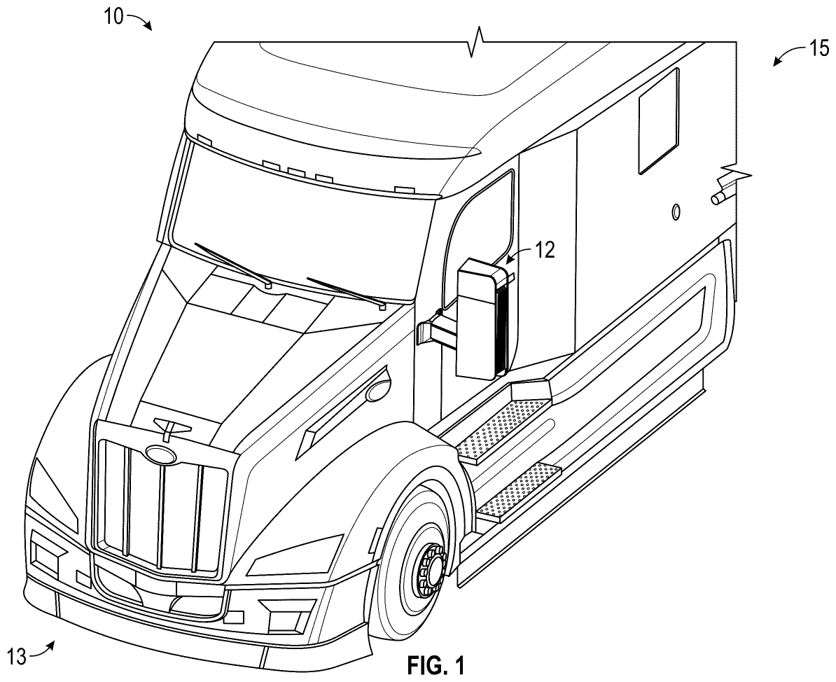

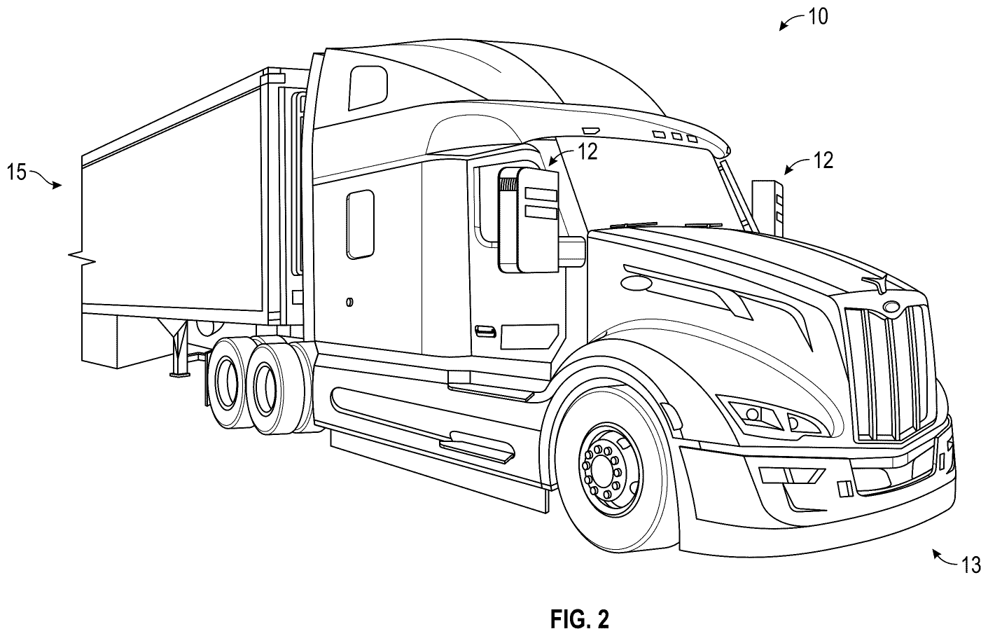

FIGS. 1 and 2 illustrate a vehicle 10 having a sensor pod 12. Although a single sensor pod 12 is illustrated in FIG. 1 and two sensor pods 12 are illustrated in FIG. 2, more or fewer may be provided. The vehicle 10 may be any motor vehicle, such as, for example, but not limited to a car, a truck, a commercial truck, a bus, a watercraft (e.g., boat, ship, underwater vehicles, etc.), a motorcycle, an aircraft (e.g., airplane, helicopter, etc.), or a spacecraft. For ease of description, the vehicle 10 may be referred to herein as a truck 10. The vehicle may have a forward side 13, also referred to as a forward end or a front end, and a rear side 15, also referred to as a rear end, rearward end, or rearward side.

With continued reference to FIGS. 1 and 2, the sensor pod 12 may be a side mirror assembly mounted to the vehicle 10. The sensor pod 12 may assist in navigation of the vehicle 10. In some examples, the sensor pod 12 may assist in navigation in a manner that results in the vehicle 10 being autonomous, self-driving, semi-autonomous, non-autonomous with assisted navigation, etc., or combinations thereof. In this regard, the sensor pod 12 may include components, such as, but not limited to, sensors and mirrors, that may be useful for the operation of the vehicle, or any combination thereof. The vehicle 10 may use (via a processor or controller) data collected by the sensor pod 12 to navigate or to assist in navigating the vehicle 10 and to control the speed, direction, braking, and other functions of the vehicle 10. By way of example, the sensor pod 12 may be, or may include the sensors, cameras, mirrors, and associated components of, the sensor pod described in International Patent Application Publication No. WO 2020/180707, the contents of which are herein incorporated by reference in their entirety. Although illustrated as mounted to the A-pillar 11 of the frame of the vehicle 10 near the driver side and passenger side doors, the sensor pod 12 may be mounted to other locations on the vehicle 10, such as, for example, but not limited to, driver side and/or passenger side doors or other locations on the frame of the vehicle 10. The mounting site of the sensor pod 12 may preferably use existing mounting points for the truck 10, or may mount with appropriate hardware to the truck structure.

As will be described in more detail to follow, and as described in International Patent Application Publication No. WO 2020/180707, the sensor pod 12 includes a variety of sensors to monitor the surroundings of the vehicle 10. The sensors may include, for example, but not limited to, one or more cameras, one or more lidars, one or more radars, and one or more inertial measurement units (IMUs). The combined data from the sensors may be used by a processor to autonomously (or semi-autonomously) navigate or to assist a driver in navigating the roadway in a variety of light conditions, weather conditions, traffic conditions, load conditions, road conditions, etc. The sensors, mirrors, and other features of the sensor pod 12 are configured and oriented to provide a predetermined field of view and to provide reliable, accurate, and high quality data for autonomous and semi-autonomous driving. The specific sensor placement and the rigidity of the connecting assembly and support structure enable a sufficient field of view while reducing vibrational disturbances and allowing a high object detection rate and high quality positional data.

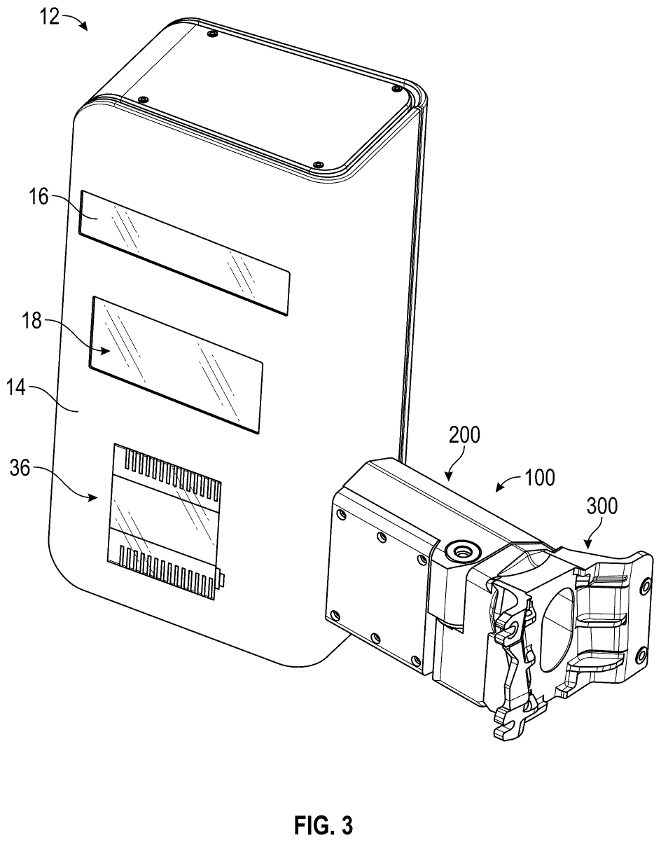

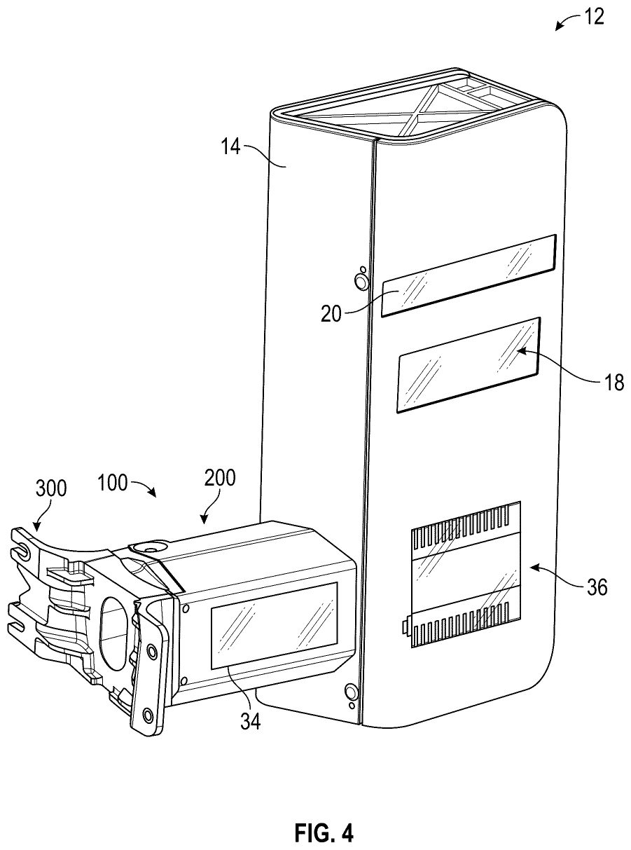

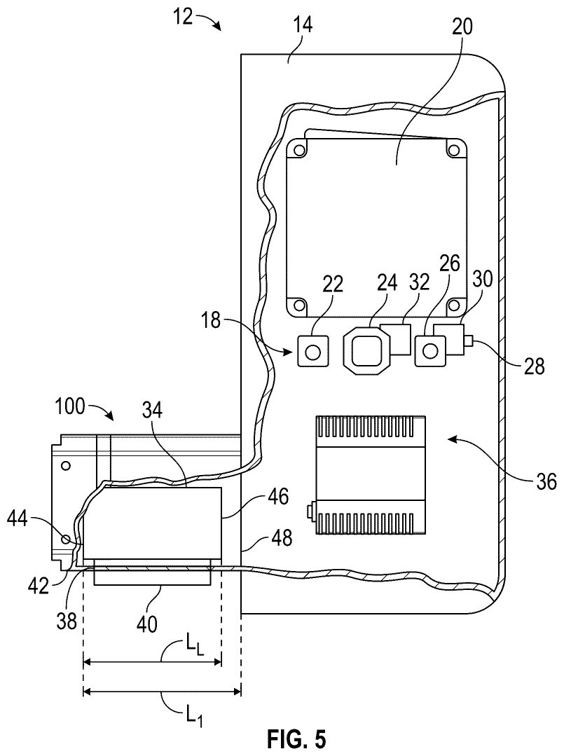

Referring to FIGS. 3 and 4, the sensor pod 12 includes a sensor pod housing 14 and a connecting assembly 100 for coupling the sensor pod 12 to the vehicle 10 (FIG. 1). FIG. 3 illustrates a view of the sensor pod 12 facing the rear side 15 and FIG. 4 illustrates a view of the sensor pod 12 facing the forward side 13. The connecting assembly 100 may include a sensor pod arm 200 and a bracket 300. The sensor pod arm 200 may be releasably coupled to the bracket 300 to allow for the sensor pod 12 to be installed, uninstalled, interchanged and/or replaced on the vehicle 10. The sensor pod arm 200 may be rotationally coupled to the bracket 300 such that relative rotation is permitted between the sensor pod 12 and each of the bracket 300 and the vehicle 10. The sensor pod 12 and/or the connecting assembly 100 may be the same as the sensor pod and connecting assembly described in U.S. application Ser. No. 17/826,000, the contents of which are herein incorporated by reference in their entirety. The sensor pod housing 14 and/or the connecting assembly 100 may house at least a portion of the sensors, cameras, mirrors, additional components, etc. required for operation of the sensor pod 12. For example, as shown in FIGS. 3 and 4, the sensor pod 12 may include a first radar 16, a camera assembly 18, and a second radar 20. The transparent windows of first radar 16, camera assembly 18, and second radar 20 are illustrated in FIGS. 3 and 4, but as shown in FIG. 5, the components themselves are internal to the sensor pod housing 14. The first radar 16 may be a rear facing radar to detect objects behind and toward the rear side 15 (FIG. 1) of the vehicle 10 (e.g., rear of the sensor pod 12). The second radar 20 may be a forward facing radar to detect objects in front of and toward the forward side 13 (FIG. 1) of the vehicle 10 (e.g., forward of the sensor pod 12). The camera assembly 18 may include a plurality of cameras, as described in more detail in FIG.

Referring to FIG. 5, a cut away view of the sensor pod housing 14 of the sensor pod 12 and of the connecting assembly 100 are shown. In the view of FIG. 5, the internal components of the sensor pod 12 and of the connecting assembly 100 are visible. The view of FIG. 5 is taken from the forward side 13 (FIG. 1) of the sensor pod 12. Conduits and wires are omitted from the cut away view of FIG. 5, however, such conduits and wires as needed for the operation of the sensor pod 12 are understood to be included within the sensor pod housing 14 and the connecting assembly 100. With the interior of the connecting assembly 100 and sensor pod 12 visible with cut away view shown, a plurality of cameras included in the camera assembly 18 are visible. For example, the camera assembly 18 may include one or more cameras facing the forward side 13 (e.g., cameras 22, 24, 26), one or more cameras facing the rear side 15 (e.g., cameras 30, 32), and one or more cameras facing a lateral side perpendicular to the forward side and rear side (e.g., camera 28). In some examples, the camera assembly may include a first narrow field of view camera 22, a thermal camera 24, a wide field of view camera 26, a side facing camera 28, a second narrow field of view camera 30, and an electronic mirror camera 32. The aforementioned cameras are merely exemplary, and any number or type of cameras may be included to facilitate the autonomous, semi-autonomous, or assisted navigation of the vehicle 10, including, the cameras described in International Patent Application Publication No. WO 2020/180707.

With continued reference to FIG. 5, the sensor pod 12 may also include a first lidar and a second lidar. The first lidar may be a forward facing lidar and may be a scanning lidar 34. The second lidar may be a spinning lidar 36. Referring back to FIGS. 3 and 4, transparent windows are included on the sensor pod housing 14 to accommodate the first lidar 34 and the second lidar 36. Referring again to FIG. 5, a heat sink 38 having cooling fins 40 may be provided with the scanning lidar 34 to dissipate or otherwise remove heat generated by the scanning lidar 34. The cooling fins 40 may be metal fins. Although only a single heat sink 38 is depicted, more or fewer may be provided. Additionally, a heat sink may be included with other sensors or cameras within the sensor pod 12 to dissipate heat as required. Additional sensors may be included in the sensor pod 12, but are omitted to facilitate description of the present disclosure. Such sensors may include any of the sensors or cameras described in International Patent Application Publication No. WO 2020/180707. The heat sink 38 may be a device or substance for absorbing excessive heat.

The scanning lidar 34, the spinning lidar 36, the first radar 16, the second radar 20, and the camera assembly 18 all provide information and data to autonomously or semi-autonomously operate and navigate the vehicle 10 and/or provide information and data to assist in the navigation of the vehicle 10 where an operator is present inside the cab of the vehicle 10. For example, the lidar may assist in tracking vehicles or objects passing or being passed by the autonomous vehicle. In an example, the radar may enable the autonomous vehicle to navigate in difficult weather and light conditions. The radar may supplement the information from the camera assembly and lidar, which may have difficulty obtaining clear images and signals in the presence of certain weather conditions, such as fog, rain, and snow. The radar may also provide information regarding objects that are occluded in the camera and lidar data. In an example the cameras may track vehicles or objects and assist in tracking of the vehicles or objects.

The scanning lidar 34 and the spinning lidar 36 may target an object or a surface with a laser and measure the time for the reflected light to return to the receiver. In this manner, the lidar are able to track vehicles and objects around the vehicle 10. The scanning lidar 34 may have a visibility only on the forward side 13. That is, the scanning lidar 34 may have a range of up to 180 degrees. Thus, the scanning lidar 34 tracks objects and vehicles on the forward side 13 of the vehicle 10. The spinning lidar 36 may have a range of 360 degrees, capable of visibility on all sides of the spinning lidar 36. Though, the truck 10 may occlude visibility. Thus, the spinning lidar 36 is capable of tracking objects and objects on the forward side 13, the rear side 15, and from the forward side 13 and the rear side 15 on the side of the sensor pod 12 away from the truck 10 (since visibility at the truck 10 is occluded by the truck 10).

The number and size of components within the sensor pod 12 define the weight and the size (e.g., length, height, depth) of the sensor pod 12. In addition to the sensors and cameras described, other components such as, for example, but not limited to, electrical conduits, hydraulic conduits, cleaning systems (e.g., liquid and/or air conduits for cleaning the sensor lenses), etc. are also provided within the connecting assembly 100 and sensor pod housing 14. Traditionally, all of the sensors, cameras, mirrors, etc. are provided within the sensor pod housing 14 and the only components provided in the connecting assembly 100 are conduits required to be connected between the vehicle 10 (FIG. 1) and the sensor pod 12. As a result, the weight and size of the sensor pod 12 is significant and is defined by the components therein. As an example, the weight of the sensor pod 12 may be about 27 kilograms and about 650 mm in height, 218 mm in depth, and 330 mm in width. These numbers are merely exemplary and the weight and size may be greater than or lesser than the mentioned values. The relatively large weight and large size (as compared to the connecting assembly 100) generates a large moment on the connecting assembly 100. The large moment requires significant structural rigidity in the connecting assembly 100 and in the specific connection of the connecting assembly 100 to the vehicle 10 in order to counteract the weight and size of the sensor pod 12.

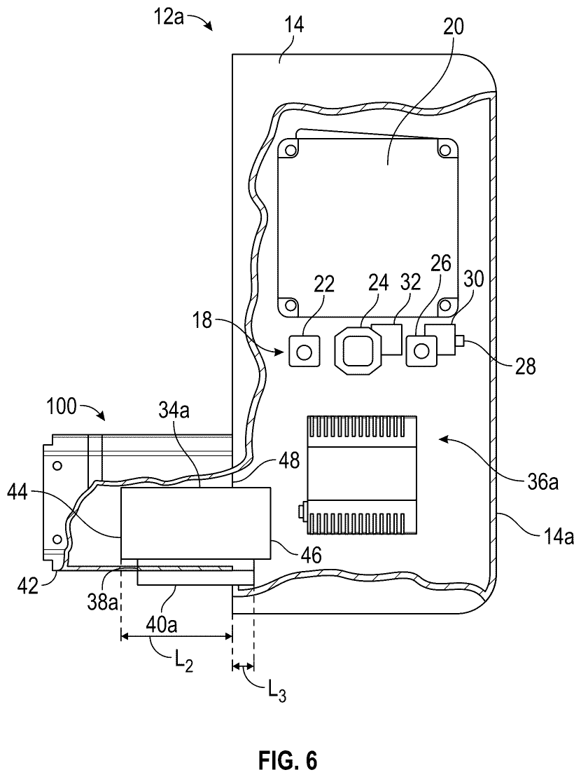

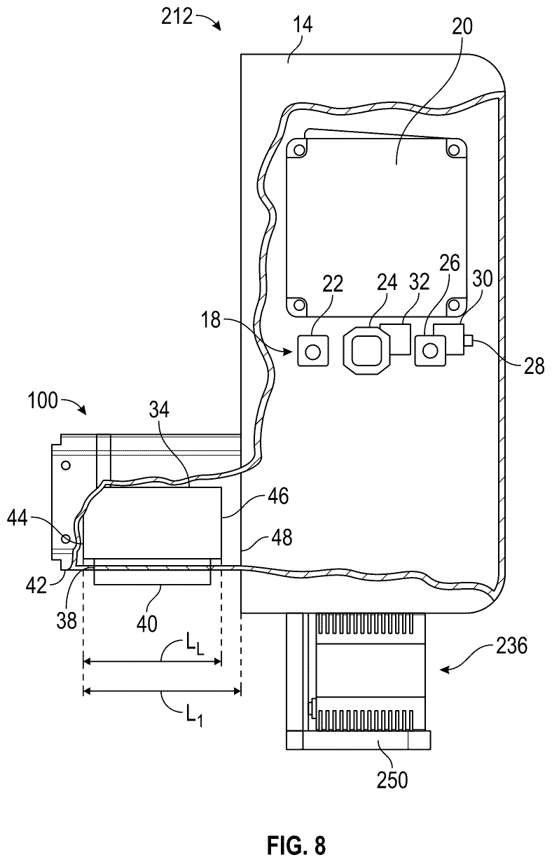

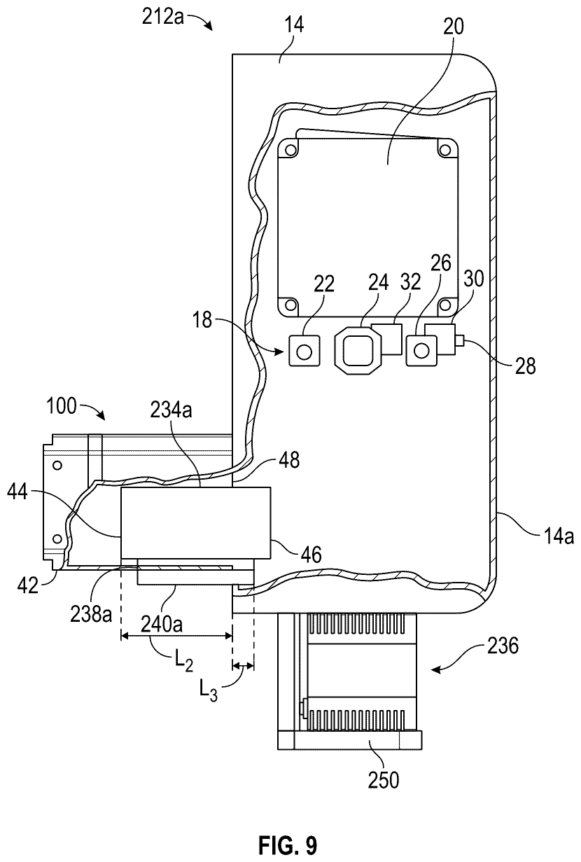

Accordingly, referring back to FIG. 5, one or more of the components traditionally located within the sensor pod housing 14 may be moved or relocated, either partially or wholly, within the connecting assembly 100. For example, the scanning lidar 34 is typically the heaviest component and widest component included in the sensor pod 12 and is also located within the sensor pod housing 14. Therefore, in some examples, the scanning lidar 34 may be moved wholly or entirely (FIGS. 5 and 8) or partially (FIGS. 6 and 9) within the connecting assembly 100. Moving the scanning lidar 34 within the connecting assembly 100 allows for the weight of the scanning lidar 34 (between about 1 kg and about 3 kg) to be moved relatively closer to the vehicle 10 and out of the sensor pod housing 14, thus reducing the moment arm created by the weight of the sensor pod 12. That is, since the scanning lidar 34 is the largest and widest sensor in the sensor pod, the scanning lidar 34 defines the moment arm created by the sensor pod 12. Movement of the scanning lidar 34 will thus, change or alter the moment arm. The closer the scanning lidar 34 is located to the vehicle 10, the smaller the moment arm will be as compared to a location farther from the vehicle 10. Thus, as the location of the scanning lidar 34 is moved closer to the vehicle, the moment arm is reduced or shortened. As the location of the scanning lidar 34 is moved farther from the vehicle, the moment arm is larger or greater.

Due to this change in the moment arm, the following disclosure describes movement of the scanning lidar, though it is understood that any of the cameras or sensors may be moved so long as visibility of the respective camera or sensor is maintained. Additionally, though the disclosure focuses on movement along the length of the connecting assembly, the scanning lidar (or other sensor) may be moved in any direction (e.g., along the width/depth, length, and/or height of the sensor pod and/or connecting assembly).

As shown in FIG. 5, the scanning lidar 34 has a length L_{L} defined between a first side 44 and a second side 46 of the scanning lidar 34. The length L_{L} is the longest dimension of the scanning lidar 34. That is, the length L_{L} may be the length, the width, and/or the height of the scanning lidar 34. As mentioned, the scanning lidar 34 is located within the connecting assembly 100. The scanning lidar 34 may extend a distance L₁ into the connecting assembly 100. The distance L₁ is defined between a first side 48 of the sensor pod housing 14 and the first side 44 of the scanning lidar 34. When the scanning lidar 34 is located wholly within the connecting assembly 100, the distance L₁ is equal to or greater than the length L_{L}.

In some examples, the scanning lidar 34 extends only into the sensor pod arm 200 (FIG. 3) of the connecting assembly 100. In some examples, the scanning lidar 34 extends into both the sensor pod arm 200 and the bracket 300 (FIG. 3) of the connecting assembly 100.

Referring to FIG. 6, a sensor pod 12a may include one or more of the sensors described with respect to FIG. 5. Components labeled with the same numbering as FIG. 5 represent the same components as described with respect to FIG. 5. The only difference in FIG. 6, as compared to FIG. 5, is the location of the scanning lidar 34a. Optionally, the location of the spinning lidar 36a may also be altered in FIG. 6, as will be discussed to follow. As mentioned previously, the scanning lidar 34 may be wholly located in the connecting assembly 100, as shown and described with respect to FIG. 5. Alternatively, only a portion of the scanning lidar 34a may be located in the connecting assembly 100. That is, that scanning lidar 34a may extend into both the connecting assembly 100 and the sensor pod housing 14. In contrast, the scanning lidar 34 of FIG. 5 extends only within the connecting assembly 100. The scanning lidar 34a may extend into the connecting assembly 100 a distance L.

As shown in FIG. 6, the scanning lidar 34a extends into the connecting assembly 100 a distance L₂ and into the sensor pod housing 14 a distance L₃. Together, the distance L₂ and the distance L₃ are equal to the length L_{L} of the scanning lidar 34a. The distance L₂ is defined between the first side 48 of the sensor pod housing 14 and the first side 44 of the scanning lidar 34a. The distance L₃ is defined between the first side 48 of the sensor pod housing 14 and the second side 46 of the scanning lidar 34a. The distance L₂ may be less than, equal to, or greater than the distance L₃. In some examples, the scanning lidar 34a extends only into the sensor pod arm 200 (FIG. 3) of the connecting assembly 100. In some examples, the scanning lidar 34a extends into both the sensor pod arm 200 and the bracket 300 (FIG. 3) of the connecting assembly 100.

As mentioned, and although not shown, in some examples, to accommodate the scanning lidar 34a extending into the sensor pod housing 14, the spinning lidar 36a may be moved laterally toward a second side 14a of the sensor pod housing 14. In some examples, and as shown in FIG. 6, the location of the spinning lidar 36a is not changed as compared to FIG. 5. A heat sink 38a with cooling fins 40a, being aligned with the scanning lidar 34a, may also extend into both the sensor pod housing 14 and the connecting assembly 100 in the manner described above. In contrast, the heat sink 38 and the fins 40 of FIG. 5 may extend only within the connecting assembly 100.

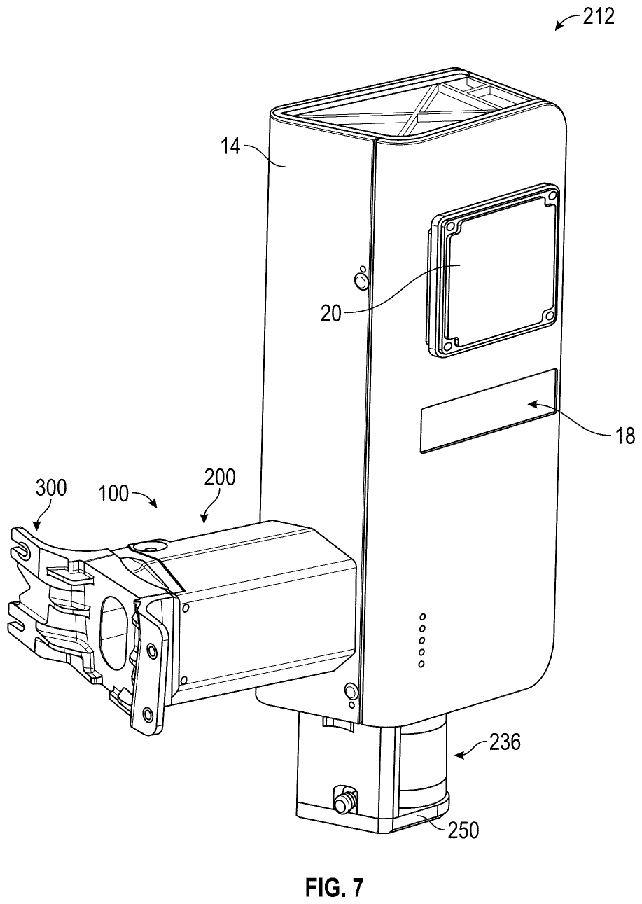

FIGS. 7 to 9 illustrate a sensor pod 212 that may be the same as the sensor pod 12 of FIGS. 3 to 6. Components labeled with the same numbering as FIG. 5 represent the same components as described with respect to FIG. 5. The only difference in FIGS. 7 and 8, as compared to FIG. 5, is the location of the spinning lidar 236. As discussed with respect to FIG. 5, the spinning lidar 36 is located within the sensor pod housing 14. Alternatively, as shown in FIGS. 7 to 9, the spinning lidar 236 may be located on a support 250 beneath the sensor pod housing 14.

In the same manner described with respect to FIG. 5, the scanning lidar 234 of FIG. 8 has a length L_{L} and is wholly located within the connecting assembly 100. The scanning lidar 234 may extend a distance L₁ into the connecting assembly 100. When the scanning lidar 234 is located wholly within the connecting assembly 100, the distance L₁ is equal to or greater than the length L_{L}. In some examples, the scanning lidar 234 extends only into the sensor pod arm 200 (FIG. 7) of the connecting assembly 100. In some examples, the scanning lidar 234 extends into both the sensor pod arm 200 and the bracket 300 (FIG. 7) of the connecting assembly 100.

FIG. 9 illustrates a sensor pod 212a that may be the same as the sensor pod 212 of FIG. 8. Components labeled with the same numbering as FIG. 8 represent the same components as described with respect to FIG. 8. The only difference in FIG. 9, as compared to FIG. 8, is the location of the scanning lidar 234. As described with respect to FIG. 8, the scanning lidar 234 may be wholly located in the connecting assembly 100. Alternatively, as shown in FIG. 9, only a portion of the scanning lidar 234a may be located in the connecting assembly 100. That is, that scanning lidar 234a may extend into both the connecting assembly 100 and the sensor pod housing 14. In contrast, the scanning lidar 234 of FIG. 8 extends only within the connecting assembly 100.

As shown in FIG. 9, the scanning lidar 234a extends into the connecting assembly 100 a distance L₂ and into the sensor pod housing 14 a distance L₃. Together, the distance L₂ and the distance L₃ are equal to the length L_{L} of the scanning lidar 234a. The distance L₂ may be less than, equal to, or greater than the distance L₃. In some examples, the scanning lidar 234a extends only into the sensor pod arm 200 (FIG. 7) of the connecting assembly 100. In some examples, the scanning lidar 234a extends into both the sensor pod arm 200 and the bracket 300 (FIG. 7) of the connecting assembly 100. A heat sink 238a with cooling fins 240a, being aligned with the scanning lidar 234a, may also extend into both the sensor pod housing 14 and the connecting assembly 100 in the manner described above.

Each of the components described with respect to FIGS. 6 to 9 may function the same as those described with respect to FIG. 5, except for the location of the components, as noted in the respective figures. Therefore, for ease of reference, the following is described with respect to FIG. 5, however, the following description also applies to FIGS. 6 to 9.

Moving the scanning lidar 34 may also allow for the size (e.g., length, height, and/or depth) of the sensor pod 12 to be reduced due to the omission of the scanning lidar 34 in the sensor pod housing 14. In some examples, the scanning lidar 34 is located within the connecting assembly 100 without increase the length, height, and/or depth of the connecting assembly. That is, the scanning lidar 34 occupies open space within the connecting assembly 100 without resizing the connecting assembly 100. In some examples, internal components (such as conduits) may need to be rearranged or adjusted to accommodate the scanning lidar 34, however, this may be done without changing the outer dimensions, outer perimeter, and/or outer shape of the connecting assembly.

In some examples, the scanning lidar 34 is located within the connecting assembly 100 and the length, height and/or depth of the connecting assembly is adjusted (e.g., increased) to accommodate the scanning lidar 34. However, when increasing the length of the connecting assembly (e.g., the distance between the truck and the sensor pod), the overall length from an outer surface of the sensor pod on the passenger side to an outer surface of the sensor pod on the driver side must be maintained below and U.S. federally regulated distance. Thus, in instances when the connecting assembly 100 is increased in length, the length of the housing (e.g., the distance of the housing 14 between the second side 14a and the first side 48) may need to be reduced to maintain the overall distance within the federally regulated distance.

In some examples, some or all of the free space once occupied by the scanning lidar 34 may be overtaken by another component. For example, the spinning lidar 36 is traditionally located on a support beneath the sensor pod housing 14 (e.g., as shown in FIGS. 7 to 9), in the examples of FIGS. 3 to 6, the spinning lidar 36 may be relocated within the sensor pod housing 14. This may reduce the risk of the spinning lidar 36 being damaged due to its location outside of the sensor pod housing 14. When the spinning lidar 36 is relocated either wholly or partially within the sensor pod housing 14, transparent windows may be provided around the entirety of the sensor pod housing 14 to allow for the spinning lidar 36 to maintain near 360 degree view.

Furthermore, the scanning lidar 34 includes a laser which generates a significant amount of heat and typically generates the most heat within the sensor pod housing 14 as compared to the other components traditionally located therein (with the exception of the spinning lidar 36 which also generates a large amount of heat due to the laser, but is not traditionally included in the sensor pod housing 14). To accommodate the heat generated by the laser, the scanning lidar 34 includes a heat sink 38 and/or a large amount of material or metal built into or around the scanning lidar 34 to dissipate heat generated by the scanning lidar 34. The heat sink 38 includes a plurality of cooling fins 40. The heat sink 38 also contributes to the weight and size of the sensor pod 12.

Thus, when moving the scanning lidar 34 into the connecting assembly 100, the heat sink 38 is also moved to a location within the connecting assembly 100. The heat sink 38 is moved to ensure proximity to the scanning lidar 34 and thus, to ensure appropriate dissipation of the heat generated by the scanning lidar 34. Moving the heat sink 38 into the connecting assembly 100 also reduces the weight and size of the sensor pod 12 and, accordingly, reduces the moment generated by the sensor pod 12.

When located in the connecting assembly 100, the heat sink 38 may be employed as a structural member of the connecting assembly 100. That is, the heat sink 38 may comprise part of the sensor pod arm 200 (FIG. 3) and/or the bracket 300 (FIG. 3). In some examples, such as the example of FIGS. 5 and 6, the heat sink 38 may form part of or all of a lower surface 42 of the connecting assembly 100. The lower surface 42 may include a lower surface of the sensor pod arm 200 and/or a lower surface of the bracket 300. As shown in FIG. 5, the fins 40 of the heat sink 38 may be flush with the lower surface 42 or may extend below the lower surface 42. The fins 40 allow for cooling by an external air flow that flows past the lower surface 42 of the connecting assembly 100. Thus, the cooling fins 40 take advantage of the air flowing past the sensor pod 12 to cool the internal components of the sensor pod 12. Such an air flow may provide cooling to the scanning lidar 34 by pulling the heat away from the scanning lidar 34. Accordingly, the placement and location of the heat sink 38 in the connecting assembly 100 provides the benefits of 1) relocating the weight of the heat sink from the sensor pod housing 14 to reduce the moment generated by the sensor pod 12, 2) using the weight of the heat sink 38 as a structural component of the connecting assembly 100, and/or 3) enhancing the heat dissipation by taking advance of an air flow past the scanning lidar 34.

Accordingly, the sensor pod of the present disclosure allows for movement and/or relocation of one or more sensors within the sensor pod to be included partially, or wholly, within the connecting assembly. Because the scanning lidar is typically the widest and largest sensor within the sensor pod housing, the most benefit is provided by moving the scanning lidar wholly or partially within the connecting assembly. However, the same or similar benefits of relocation may be achieved by moving one or more of the other sensors (e.g., lidar or radar) or cameras into (partially or wholly) the connecting assembly, in lieu of, or in addition to, moving the scanning lidar.

Since the scanning lidar is typically the largest and widest sensor, movement, even partially, into the connecting assembly allows for at least the width of the sensor pod housing to be reduced. This reduces the extent to which the sensor pod extends from the vehicle, thus reducing the overall width of the vehicle. This is important since aerodynamic drag occurs at the sensor pod. Reducing the width of the sensor pod housing reduces the drag occurring on the sensor pod. Additionally, moving at least a portion of the weight of the scanning lidar into the connecting assembly reduces the moment generated by the sensor pod.

Additionally, due to the inclusion of a laser, the scanning lidar generates a heat. There is typically more heat generation in the lidar (both scanning and spinning) as compared to other sensors within the sensor pod. Thus, a heat sink is included on the bottom of the lidar (where all of the heat generating elements of the lidar are typically located) to dissipate the heat generated by the lidar.

The location of the sensors within the sensor pod are particularly chosen to achieve a predetermined function. For example, the scanning lidar is located on the forward side 13 to achieve scanning in front of the vehicle. In another example, the spinning lidar is located on a support or near the outer portion of the sensor pod housing to allow for near 360 degrees (some exclusion of view by the vehicle is expected). Thus, there is a balance when relocating components, such as sensor, to improve the mechanical benefit of the sensor while maintaining the functionality and operation of the sensor. For example, moving the sensors closer to the vehicle may increase the interference from the vehicle and/or may reduce the view of the sensor, thus impacting the functionality and operation of the sensor. On the other hand, moving the sensors closer to the vehicle reduces the weight of the sensor pod being cantilevered by the connecting assembly. That is, the moment arm is shortened and the sensor pod weighs less. This improves the mechanical benefit and modularity of the sensor pod. Accordingly, the location of the sensors, and in particular, the scanning lidar as described herein, is selected to balance the mechanical benefits and the operability of the sensors.

In some examples, the length of the connecting assembly 100 may be extended to accommodate the location of the scanning lidar, either partially or wholly, within the connecting assembly 100. However, the maximum width of the vehicle (from passenger side sensor pod to driver side sensor pod) may remain the same or may even be reduced, as compared to a sensor pod with the scanning lidar within the sensor pod housing. This is due to the fact that the maximum width is federally regulated in the United States. Thus, movement of any of the sensors within the connecting assembly 100 is done so in a manner which either reduces the maximum width (e.g., by reducing the width of the sensor pod housing) or maintains the maximum width (e.g., by not changing the dimensions of the connecting assembly or sensor pod housing or by lengthening the connecting assembly and shortening the sensor pod housing).

In some examples, the arrangements described herein thus allow for a dense sensor pod or dense sensor pod configuration. That is, by moving the scanning lidar into the connecting assembly, the sensor pod housing may be reduced in size (e.g., at least may be reduced in width), and thus may closely compact and/or closely crowd the sensors into a dense configuration where the sensors and cameras and some or all of the components of the sensor pod are closely grouped or closely arranged.

Although not shown in the figures or shown only schematically in the figures, for ease of description, the structure, shape, and/or material of the connecting assembly 100 and the sensor pod housing 14 is such that the scanning lidar, the spinning lidar, the cameras, and the radar are allowed to function and operate as required to gather information and data. That is, for example, the structure and/or material may be transparent, may include windows, may be certain types of plastic, or any other structure and/or material to allow the lidar, cameras, and radar to have visibility outside of the sensor pod housing 14 and connecting assembly 100. In some examples, the material, structure, or shape of the sensor pod housing 14 and/or the connecting assembly 100 may be variable. That is, where visibility is required for internal sensors and cameras, the structure, shape, and/or material may be such as to permit visibility and elsewhere the structure, shape, and/or material may not permit visibility. For example, windows or transparent materials may be provided for the sensors and cameras and elsewhere, the materials may be solid without windows and without transparent materials.

The present disclosure further includes a method of assembling a sensor pod assembly. The method includes coupling a connecting assembly to a housing of a sensor pod. The coupling may be with fasteners, welding, casting, machining, molding, or any known manufacturing method. The sensor pod may be outfitted with sensors, cameras, mirrors, and the like before or after coupling to the connecting assembly. A scanning lidar may be installed in a cavity of the connecting assembly. The method may include determining a moment arm of the assembly. Subsequent movement of the scanning lidar within the cavity of the connecting assembly may be performed to adjust the moment arm. Prior to or after the scanning lidar is installed within the connecting assembly, conduits may be inserted into the cavity to all for coupling to a conduit connection at the interface of the sensor pod arm of the connecting assembly and the sensor pod. The conduits may be rearranged, moved or relocated to accommodate the scanning lidar. Optionally, a spinning lidar may be installed within the sensor pod housing 14. In other methods, the spinning lidar may be installed on a support below the sensor pod housing 14. A back plate may be installed over the cavity housing the scanning lidar and the conduits. The back plate may be secured to the connecting assembly. At this stage, the sensor pod assembly is properly assembled and the sensor pod may be installed on the vehicle.

Further aspects of the present disclosure are provided by the subject matter of the following clauses.

According to an aspect of the present disclosure, a dense sensor pod assembly for a vehicle includes a sensor pod housing having one or more sensors located within the sensor pod housing, a connecting assembly for coupling the sensor pod housing to the vehicle, and a scanning lidar located within the connecting assembly, wherein the scanning lidar, the connecting assembly, and the sensor pod housing form a dense sensor pod configuration.

The dense sensor pod assembly of the preceding clause, wherein the scanning lidar is wholly located within the connecting assembly.

The dense sensor pod assembly of any preceding clause, wherein the scanning lidar is partially located within the connecting assembly and partially located within the sensor pod housing.

The dense sensor pod assembly of any preceding clause, wherein the scanning lidar is heavier than each of the one or more sensors.

The dense sensor pod assembly of any preceding clause, wherein the scanning lidar is wider than each of the one or more sensors.

The dense sensor pod assembly of any preceding clause, wherein a location of the scanning lidar defines a moment arm generated by the sensor pod housing on the connecting assembly.

The dense sensor pod assembly of any preceding clause, the connecting assembly further including one or more conduits coupled between the vehicle and the sensor pod housing.

The dense sensor pod assembly of any preceding clause, wherein the one or more sensors includes a spinning lidar.

The dense sensor pod assembly of any preceding clause, wherein the spinning lidar is located wholly within the sensor pod housing.

The dense sensor pod assembly of any preceding clause, wherein the spinning lidar is located on a support beneath the sensor pod housing.

The dense sensor pod assembly of any preceding clause, wherein the one or more sensors includes one or more radars, one or more cameras, or a combination thereof.

The dense sensor pod assembly of any preceding clause, further including a heat sink coupled to the scanning lidar to dissipate heat generated by the scanning lidar.

The dense sensor pod assembly of any preceding clause, wherein the heat sink is a structural component of the connecting assembly.

The dense sensor pod assembly of any preceding clause, wherein the structural component is a lower surface of the connecting assembly.

The dense sensor pod assembly of any preceding clause, wherein the connecting assembly includes a sensor pod arm and a bracket, and wherein the lower surface of the connecting assembly is a lower surface of the sensor pod arm, a lower surface of the bracket, or a combination thereof.

According to an aspect of the present disclosure, a dense sensor pod assembly for a vehicle includes a sensor pod housing, a connecting assembly for coupling the sensor pod housing to the vehicle, and one or more sensors located within the connecting assembly, wherein the one or more sensors, the connecting assembly, and the sensor pod housing form a dense sensor pod configuration.

The dense sensor pod assembly of any preceding clause, wherein the one or more sensors is one or more radar, one or more lidars, one or more cameras, or a combination thereof.

The dense sensor pod assembly of any preceding clause, wherein the one or more sensors is wholly located within the connecting assembly.

The dense sensor pod assembly of any preceding clause, wherein the one or more sensors is partially located within the connecting assembly and partially located within the sensor pod housing.

The dense sensor pod assembly of any preceding clause, wherein the one or more sensors is heavier than any other sensor of one or more sensors.

The dense sensor pod assembly of any preceding clause, wherein the one or more sensors is wider than any other sensor of the one or more sensors.

The dense sensor pod assembly of any preceding clause, wherein a location of one of the one or more sensors defines a moment arm generated by the sensor pod housing on the connecting assembly.

The dense sensor pod assembly of any preceding clause, the connecting assembly further including one or more conduits coupled between the vehicle and the sensor pod housing.

The dense sensor pod assembly of any preceding clause, wherein the one or more sensors includes a spinning lidar.

The dense sensor pod assembly of any preceding clause, wherein the spinning lidar is located wholly within the sensor pod housing.

The dense sensor pod assembly of any preceding clause, wherein the spinning lidar is located on a support beneath the sensor pod housing.

The dense sensor pod assembly of any preceding clause, further including a heat sink coupled to the one or more sensors to dissipate heat generated by the one or more sensors.

The dense sensor pod assembly of any preceding clause, wherein the heat sink is a structural component of the connecting assembly.

The dense sensor pod assembly of any preceding clause, wherein the structural component is a lower surface of the connecting assembly.

The dense sensor pod assembly of any preceding clause, wherein the connecting assembly includes a sensor pod arm and a bracket, and wherein the lower surface of the connecting assembly is a lower surface of the sensor pod arm, a lower surface of the bracket, or a combination thereof.

According to an aspect of the present disclosure, a connecting assembly for coupling a sensor pod to a vehicle includes an arm, and a scanning lidar located within the arm.

The connecting assembly of the preceding clause, further including one or more conduits located within the arm.

The connecting assembly of any preceding clause, wherein the scanning lidar is wholly located within the arm.

The connecting assembly of any preceding clause, wherein the scanning lidar is partially located within the arm.

The connecting assembly of any preceding clause, further including a heat sink having cooling fins.

The connecting assembly of any preceding clause, wherein the heat sink is a structural component of the arm.

The connecting assembly of any preceding clause, wherein the heat sink forms a lower surface of the arm.

The connecting assembly of any preceding clause, wherein the arm includes a sensor pod arm and a bracket, and wherein the lower surface is a lower surface of the sensor pod arm, a lower surface of the bracket, or a combination thereof.

The connecting assembly of any preceding clause, the arm further including a sensor pod arm and a bracket.

The connecting assembly of any preceding clause, wherein the sensor pod arm is rotationally coupled to the bracket.

The connecting assembly of any preceding clause, wherein the scanning lidar is located entirely within the sensor pod arm.

The connecting assembly of any preceding clause, wherein the scanning lidar is located within the sensor pod arm and the bracket.

The connecting assembly of any preceding clause, wherein the scanning lidar is located entirely within the sensor pod arm and the bracket, such that a portion of the scanning lidar is located in the sensor pod arm and a portion of the scanning lidar is located in the bracket.

The connecting assembly of any preceding clause, wherein the scanning lidar is located partially within the sensor pod arm, partially within the bracket, and partially within the sensor pod.

The connecting assembly of any preceding clause, wherein a location of the scanning lidar defines a moment arm generated by the sensor pod housing on the connecting assembly.

The connecting assembly of any preceding clause, wherein the scanning lidar is the only sensor located in the connecting assembly.

The connecting assembly of any preceding clause, wherein no cameras, no radar, no other lidars, and no other sensors are located in the arm.

A connecting assembly for coupling a sensor pod to a vehicle includes an arm, a scanning lidar located within the arm, and a heat sink located within the arm.

The connecting assembly of any preceding clause, further including one or more conduits located within the arm.

The connecting assembly of any preceding clause, wherein the scanning lidar and the heat sink are wholly located within the arm.

The connecting assembly of any preceding clause, wherein the scanning lidar and the heat sink are partially located within the arm.

The connecting assembly of any preceding clause, wherein the heat sink forms a portion of a lower surface of the arm and includes cooling fins extending from and below the lower surface.

The connecting assembly of any preceding clause, wherein the arm includes a sensor pod arm and a bracket, and wherein the lower surface is a lower surface of the sensor pod arm, a lower surface of the bracket, or a combination thereof.

The connecting assembly of any preceding clause, the arm further including a sensor pod arm and a bracket.

The connecting assembly of any preceding clause, wherein the sensor pod arm is rotationally coupled to the bracket.

The connecting assembly of any preceding clause, wherein the scanning lidar and the heat sink are located entirely within the sensor pod arm.

The connecting assembly of any preceding clause, wherein the scanning lidar and the heat sink are located partially within the sensor pod arm, partially within the bracket, and partially within the sensor pod.

The connecting assembly of any preceding clause, wherein a location of the scanning lidar and the heat sink defines a moment arm generated by the sensor pod housing on the connecting assembly.

The connecting assembly of any preceding clause, wherein the scanning lidar is the only sensor located in the arm.

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A dense sensor pod assembly for a vehicle, the dense sensor pod assembly comprising:
a sensor pod housing having one or more sensors located within the sensor pod housing;
a connecting assembly for coupling the sensor pod housing to the vehicle; and
a scanning lidar located within the connecting assembly, wherein the scanning lidar, the connecting assembly, and the sensor pod housing form a dense sensor pod configuration.

2. The dense sensor pod assembly of claim 1, wherein the scanning lidar is wholly located within the connecting assembly.

3. The dense sensor pod assembly of claim 1, wherein the scanning lidar is partially located within the connecting assembly and partially located within the sensor pod housing.

4. The dense sensor pod assembly of claim 1, wherein the scanning lidar is heavier than each of the one or more sensors.

5. The dense sensor pod assembly of claim 1, wherein the scanning lidar is wider than each of the one or more sensors.

6. The dense sensor pod assembly of claim 1, wherein a location of the scanning lidar defines a moment arm generated by the sensor pod housing on the connecting assembly.

7. The dense sensor pod assembly of claim 1, the connecting assembly further comprising one or more conduits coupled between the vehicle and the sensor pod housing.

8. The dense sensor pod assembly of claim 1, wherein the one or more sensors comprises a spinning lidar.

9. The dense sensor pod assembly of claim 8, wherein the spinning lidar is located wholly within the sensor pod housing.

10. The dense sensor pod assembly of claim 8, wherein the spinning lidar is located on a support beneath the sensor pod housing.

11. The dense sensor pod assembly of claim 1, wherein the one or more sensors comprises one or more radars, one or more cameras, or a combination thereof.

12. The dense sensor pod assembly of claim 1, further comprising a heat sink coupled to the scanning lidar to dissipate heat generated by the scanning lidar.

13. The dense sensor pod assembly of claim 12, wherein the heat sink is a structural component of the connecting assembly.

14. The dense sensor pod assembly of claim 13, wherein the structural component is a lower surface of the connecting assembly.

15. The dense sensor pod assembly of claim 14, wherein the connecting assembly comprises a sensor pod arm and a bracket, and wherein the lower surface of the connecting assembly is a lower surface of the sensor pod arm, a lower surface of the bracket, or a combination thereof.

16. A dense sensor pod assembly for a vehicle, the dense sensor pod assembly comprising:
a sensor pod housing;
a connecting assembly for coupling the sensor pod housing to the vehicle; and
one or more sensors located within the connecting assembly, wherein the one or more sensors, the connecting assembly, and the sensor pod housing form a dense sensor pod configuration.

17. The dense sensor pod assembly of claim 16, wherein the one or more sensors is one or more radar, one or more lidars, one or more cameras, or a combination thereof.

18. The dense sensor pod assembly of claim 16, wherein the one or more sensors is wholly located within the connecting assembly.

19. The dense sensor pod assembly of claim 16, wherein the one or more sensors is partially located within the connecting assembly and partially located within the sensor pod housing.

20. The dense sensor pod assembly of claim 16, wherein the one or more sensors is heavier than any other sensor of one or more sensors.

21. The dense sensor pod assembly of claim 16, wherein the one or more sensors is wider than any other sensor of the one or more sensors.

22. The dense sensor pod assembly of claim 16, wherein a location of one of the one or more sensors defines a moment arm generated by the sensor pod housing on the connecting assembly.

23. The dense sensor pod assembly of claim 16, the connecting assembly further comprising one or more conduits coupled between the vehicle and the sensor pod housing.

24. The dense sensor pod assembly of claim 16, wherein the one or more sensors comprises a spinning lidar.

25. The dense sensor pod assembly of claim 24, wherein the spinning lidar is located wholly within the sensor pod housing.

26. The dense sensor pod assembly of claim 24, wherein the spinning lidar is located on a support beneath the sensor pod housing.

27. The dense sensor pod assembly of claim 16, further comprising a heat sink coupled to the one or more sensors to dissipate heat generated by the one or more sensors.

28. The dense sensor pod assembly of claim 27, wherein the heat sink is a structural component of the connecting assembly.

29. The dense sensor pod assembly of claim 28, wherein the structural component is a lower surface of the connecting assembly.

30. The dense sensor pod assembly of claim 29, wherein the connecting assembly comprises a sensor pod arm and a bracket, and wherein the lower surface of the connecting assembly is a lower surface of the sensor pod arm, a lower surface of the bracket, or a combination thereof.
